(19) United States
(12) Patent Application Publication
(10) Pub. No.: US 2008/0206467 A1
(43) Pub. Date: Aug. 28, 2008

(54) Method of prevention of coating defects

(76) Inventors: Vlad Mitlin, San Diego, CA (US); Carole Lee Anderson, San Diego, CA (US)

Correspondence Address: Vlad Mitlin, 15358 Calle Juanito, San Diego, CA, 92129, US

(21) Appl. No.: 11/710,063

(22) Filed: Feb. 23, 2007

(51) Int. Cl. B05D 3/00

(52) U.S. Cl. 427/299

(57) ABSTRACT

In accordance with the present invention, a method of prevention of defects in uniform coatings is proposed. The method comprises decelerating the advancement of the dewetting front of a coating attained by externally controlling the wettability and the size of a buffer zone at the boundary of the coating area. The surface of the buffer zone should have better wettability with respect to the fluid in the coating than the surface of the coating area.

### FIELD OF THE INVENTION

The present invention relates to prevention of defects in uniform coatings for the coatings industry.

### BACKGROUND OF THE INVENTION

Prevention of defects in uniform coatings is an important problem in the coatings industry. Hardening of a fluid coating frequently initiates the formation of defects which is due to the dewetting process (receding of a film of a negative or intermediate wettability from a substrate). As the formation of defects occurs while the coating is hardening, the characteristic time of formation of a defect plays a crucial role in developing a uniform coating. To reduce the number of defects in the coating, the characteristic time of development of a defect in the hardening film should be minimized.

This invention introduces a method of prevention of defects in uniform coatings by kinetically stabilizing a non-wetting fluid film on a solid substrate by externally controlling wettability properties at the boundary of the coating area. Specifically, this invention comprises decelerating the advancement of the dewetting front of a coating attained by controlling the wettability and the size of a buffer zone at the boundary of the coating area.

The present application claims priority to the U.S. patent disclosure no. 609905 titled: “Kinetic Stabilization of Dewetting” filed on 8 Dec. 2006 by Vlad Mitlin.

### SUMMARY OF THE INVENTION

In accordance with the present invention, a method of prevention of defects in uniform coatings is proposed. The method comprises decelerating the advancement of the dewetting front of a coating attained by externally controlling the wettability and the size of a buffer zone at the boundary of the coating area. The surface of the buffer zone should have better wettability with respect to the fluid in the coating than the surface of the coating area.

### BRIEF DESCRIPTION OF THE DRAWINGS

A complete understanding of the present invention may be obtained by reference to the accompanying drawings, when considered in conjunction with the subsequent, detailed description, in which:

FIG. 1 presents the potential (2.2) (crosses) and its entropic approximation (2.1) (circles) at R=−0.1, N=10, and M=31;

FIG. 2 presents the potential (2.2) (crosses) and its entropic approximation (2.1) (circles) at R=−0.1, N=100, and M=31;

FIG. 3 presents an inverse of the second derivative of the disjoining potential (3.3) versus the dimensionless thickness;

FIG. 4 presents the disjoining potential (3.3) versus the dimensionless thickness;

FIG. 5 presents the disjoining pressure (3.5) versus the dimensionless thickness;

FIG. 6 shows the development of a growing dry spot described by solution (4.1) at m=0.001 and t=100n, n=0, . . . ,200;

FIG. 7 shows the thickness profile of a growing dry spot described by solution (4.1) at m=1 and t=10n, n=0, . . . ,20;

FIG. 8 shows the size of a dry spot after unit time versus the parameter m;

FIG. 9 shows an advancement of the dewetting front of a non-wetting film in contact with a dry semi-space through a “buffer” of a wetting film described by the solution (6.1), (6.2) at m=0.001, R=1, and t=0, . . . ,100;

FIG. 10 shows an advancement of the dewetting front of a non-wetting film in contact with a dry semi-space through a “buffer” of a wetting film described by the solution (6.1), (6.2) at m=0.01, R=1, and t=0, . . . ,100;

FIG. 11 shows an advancement of the dewetting front of a non-wetting film in contact with a dry semi-space through a “buffer” of a wetting film described by the solution (6.1), (6.2) at m=0.1, R=1, and t=0, . . . ,100;

FIG. 12 shows an advancement of the dewetting front of a non-wetting film in contact with a dry semi-space through a “buffer” of a wetting film described by the solution (6.1), (6.2) at m=1, R=1, and t=0, . . . ,100;

FIG. 13 shows an advancement of the dewetting front of a non-wetting film in contact with a dry semi-space through a “buffer” of a wetting film described by the solution (6.1), (6.2) at m=1, R=10, and t=0, . . . ,100;

FIG. 14 shows the dynamics of the position of the dewetting front X*(t) at R=1 and m=1, at D=22.2 (left curve) and D=34.4 (right curve);

FIG. 15 presents results of a coating experiment with acrylic paint on sticker backing paper: the left rectangle has a wettable buffer zone, and the right rectangle does not;

FIG. 16 presents results of a coating experiment with enamel hobby paint on sticker backing paper: the painted rectangle has no buffer zone;

FIG. 17 presents results of a coating experiment with enamel hobby paint on sticker backing paper: the painted rectangle has a wettable buffer zone;

FIG. 18 shows the schematics of the proposed method of prevention of defects in a uniform coating: a buffer zone is shown in white, the coating area is shown in black, and the rest of substrate is shown in gray; and

FIG. 19 shows the schematics of a wettability-reinforced coating; a hexagonal mesh of a buffer material is shown in white while the coating area is shown in black.

For purposes of clarity and brevity, like elements and components will bear the same designations and numbering throughout the FIGURES.

### DESCRIPTION OF THE PREFERRED EMBODIMENT

In the following description, numerous specific details are set forth in order to provide a thorough understanding of the present invention. It will be obvious to one skilled in the art that the present invention may be practiced without these specific details. In other instances, well-known circuits, structures and techniques have not been shown in detail in order not to unnecessarily obscure the present invention.

1. Introduction

Dewetting of a solid surface is usually simulated by numerically solving a nonlinear equation of the Cahn-Hilliard type (Mitlin, 1993). Analytical solutions of this equation have been unknown. It is desirable to develop such a solution.

In this document we present a first, to the best of our knowledge, analytical description of the dewetting problem in the entire range of times, for this type of model. It is based on exact solutions of a nonlinear parabolic equation of the second order describing spinodal decomposition of a binary mixture with an entropic (or more accurately, anti-entropic) potential obtained recently in Mitlin, 2006. It properly accounts for the disjoining pressure dependence (an inverse cube of the film thickness) of a non-wetting film. The model predicts that the size of dry zones grows linearly with time.

The material in this document is structured as follows: first, we will describe the model of spinodal decomposition with the entropic potential; next, we will show that this model may be used to describe the dewetting dynamics; then, exact solutions of this model will be presented; then, we will describe a method of kinetic stabilization of a non-wetting film on a solid substrate by externally controlling wettability properties at the boundary of the coating area; finally, we will present experimental corroborations of this theory and describe a method of prevention of defects in uniform coatings based on this theory.

2. A Model of Spinodal Decomposition with an Entropic Potential

Consider the spinodal decomposition with a potential in the form:

F=R·(U1nU+(1−U)1n(1−U)) (2.1)

where U is the composition of a binary mixture and R is the criticality parameter so R=0 and U=½ correspond to the critical point. The potential F approximates the following free energy function:

$$F = \frac{1}{N} ( U ln U + ( 1 - U ) ln ( 1 - U ) ) + χ ( 1 - U ) U {\sum }_{n = 0}^{M} \frac{{U}^{n} + {( 1 - U )}^{n}}{n + 1} \qquad ( 2.2 )$$

with an effective interaction parameter

$$χ = - R + \frac{1}{N} \qquad ( 2.3 )$$

and M>>1. Eq. (2.2) describes a binary polymer mixture and accounts for higher-order (M-ary) interactions between monomers of the first and second components of the mixture while the topological structures of molecules are identical.

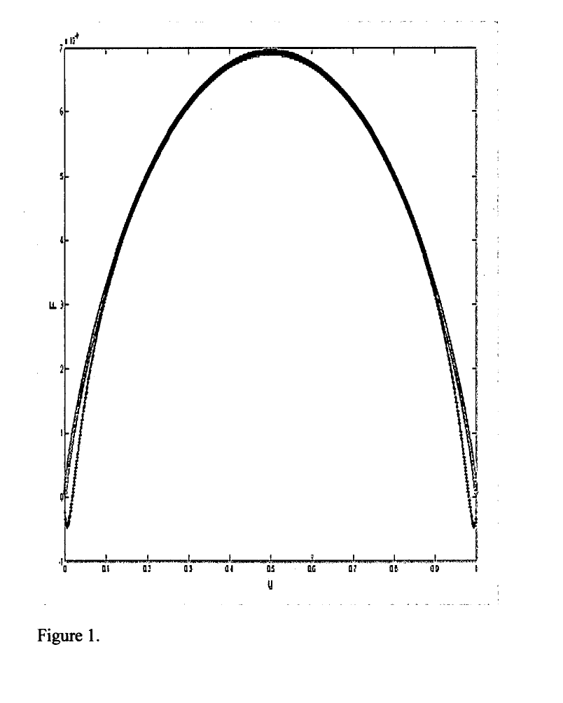

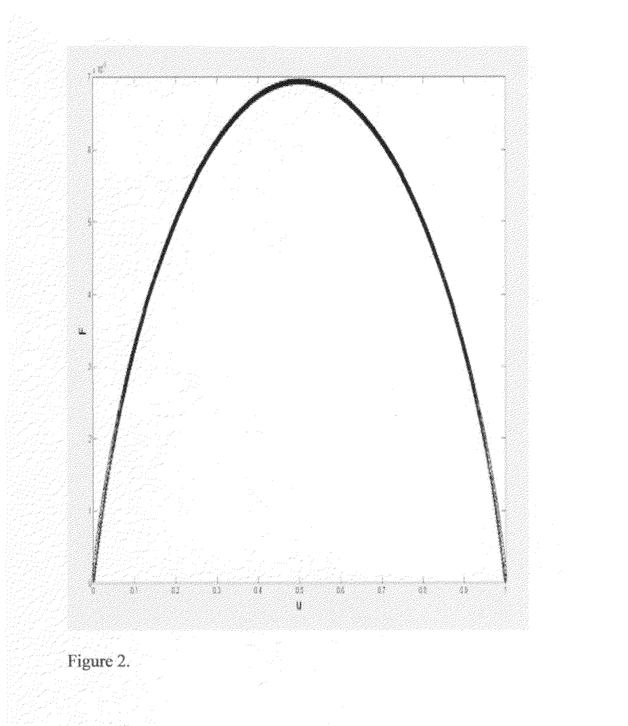

FIG. 1 shows the potential (2.2) (crosses) at R=−0.1, N=10, and M=31. The corresponding potential (2.1) is shown by circles. FIG. 2 shows the potentials (2.2) and (2.1) at R=−0.1, N=100, and M=31. An increase in the polymerization degree N improves the convergence of these two potentials.

The spinodal decomposition dynamics of this system can be described by the following equation:

$$\frac{\partial U}{\partial t} = \frac{{\partial }^{2}}{\partial {x}^{2}} ( \frac{\partial F}{\partial U} ) \qquad ( 2.4 )$$

where F is given by Eq. (2.1).

3. The Dewetting Model

What does the model presented in Section 2 have to do with dewetting?

Let us look again at the equation (2.4) and map it to the following thin film equation in a dimensionless form:

$$\frac{\partial U}{\partial t} = \frac{\partial }{\partial X} ( {U}^{3} \frac{\partial }{\partial X} ( \frac{\partial G}{\partial U} ) ) \qquad ( 3.1 )$$

In Eq. (3.1) U is the dimensionless film thickness; and G is the dimensionless disjoining potential (Deryagyin, Churaev, & Muller, 1987) defined as follows:

$$G = \int d U ( \int \frac{{\partial }^{2} F ( U )}{\partial {U}^{2}} \frac{d U}{{U}^{3}} ) \qquad ( 3.2 )$$

Introducing Eq. (2.1) into Eq. (3.2) yields:

$$G = - \frac{1}{6 {U}^{2}} - \frac{1}{2 U} - ( 1 - U ) ln ( \frac{1 - U}{U} ) \qquad ( 3.3 )$$

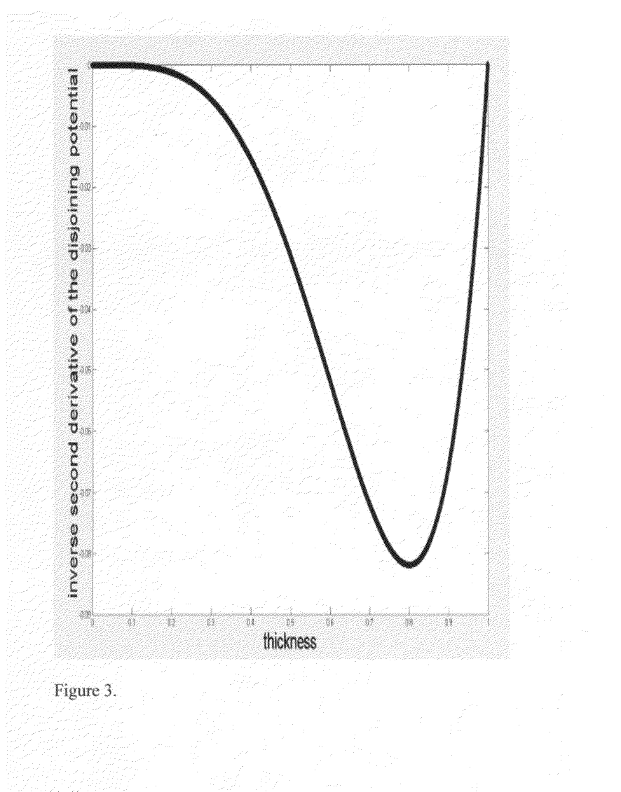

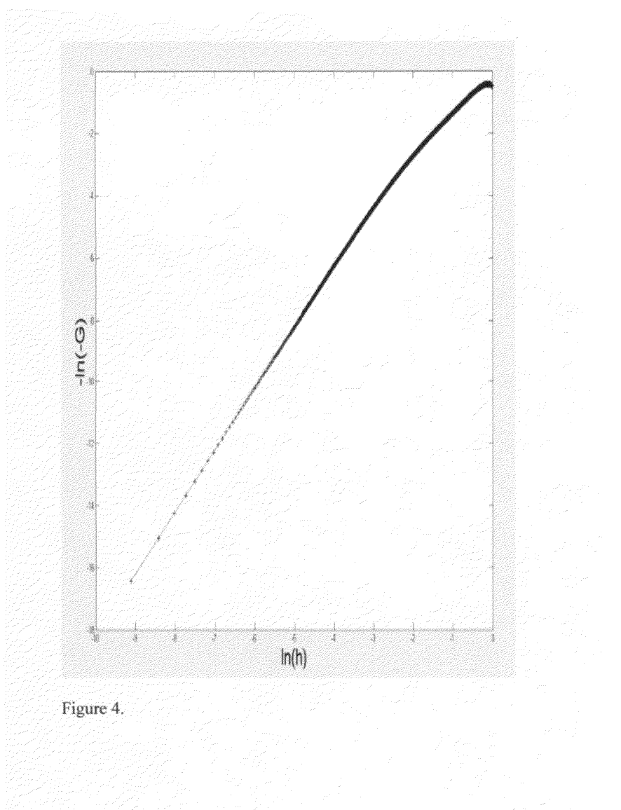

FIG. 3 shows the inverse of the second derivative of G by U. It is non-positive for all O<U<1 and vanishes at U=0 and U=1. In other words, in this model there are no metastable states: evolution here is driven by pure instability. The potential itself is shown in FIG. 4, and it looks qualitatively similar to what is shown in FIG. 3.

The dimensionless disjoining pressure

$$Π = - \frac{\partial G}{\partial U} \qquad ( 3.4 )$$

corresponding to the potential (3.3) is:

$$Π = - \frac{1}{3 {U}^{3}} - \frac{1}{2 {U}^{2}} - \frac{1}{U} - ln ( \frac{1 - U}{U} ) \qquad ( 3.5 )$$

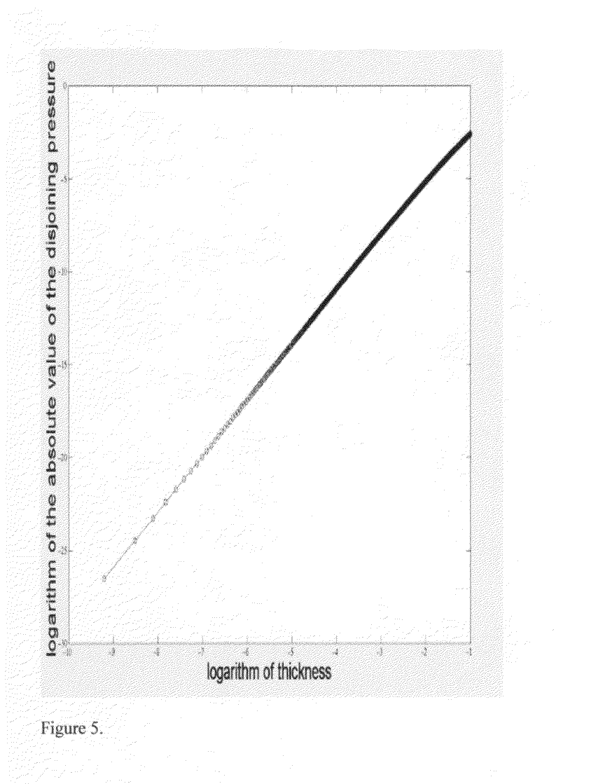

This dependence is shown in FIG. 5. As 1/U³ is the leading term in Eq. (3.5), the disjoining pressure follows the 1/U³ law almost in the entire thickness range. The logarithmic term in Eq. (3.5) restricts the applicability of Eq. (3.1) to the range 0<U<1; and U=1 corresponds to the equilibrium film thickness h*.
The dimensional form of Eq. (3.1) is:

$$\frac{\partial h}{\partial τ} = - \frac{\partial }{\partial x} ( \frac{{h}^{3}}{3 η} \frac{\partial P ( h )}{\partial x} ) \qquad ( 3.6 )$$

In Eq. (3.6) h is the film thickness; Ti is the fluid viscosity; P is the disjoining pressure,

$$P = - \frac{A}{{h}^{* 3}} ( \frac{{h}^{* 3}}{3 {h}^{3}} + \frac{{h}^{* 2}}{2 {h}^{2}} + \frac{{h}^{*}}{h} + ln ( \frac{{h}^{*} - h}{h} ) ) \qquad ( 3.7 )$$

and A is the Hamaker constant. Comparing Eqs. (3.1) and (3.7) allows us to relate dimensionless thickness, the spatial coordinate, and time in Eq. (3.1) to their dimensional counterparts in Eq. (3.7) as follows:

$$U = h / {h}^{*} ; X = x / {h}^{*} ; t = τ ( \frac{\vert A \vert}{3 η {h}^{* 3} } ) \qquad ( 3.8 )$$

### 4. Coalescence in the Model (3.1).

In this section we will present a solution of Eq. (3.1) describing the coalescence of dry zones. The solution is derived using the μ-transform. For details of the derivation, we refer an interested reader to the monograph (Mitlin, 2006). The final result is:

$$X = \pm \frac{2}{\sqrt{m}} {cosh}^{- 1} ( \sqrt{\frac{tmU}{2 ( 1 - U )}} ) \pm t \sqrt{m} \cdot tanh ( {cosh}^{- 1} ( \sqrt{\frac{tmU}{2 ( 1 - U )}} ) ) \qquad ( 4.1 )$$

where X is the spatial coordinate.

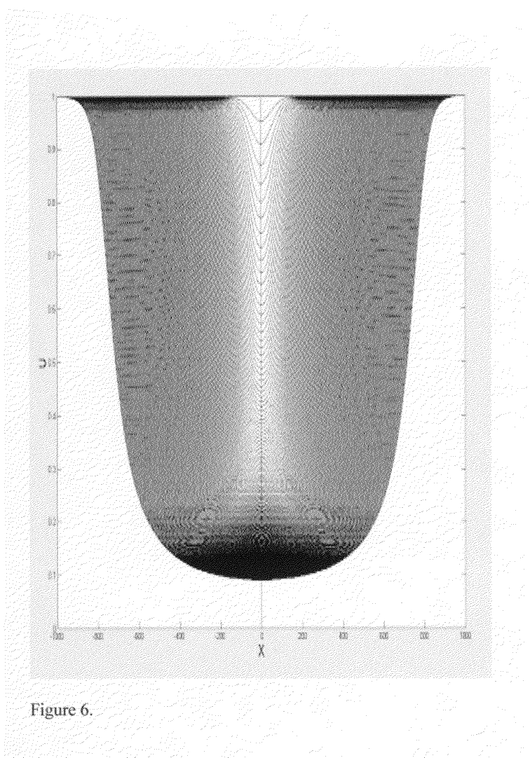

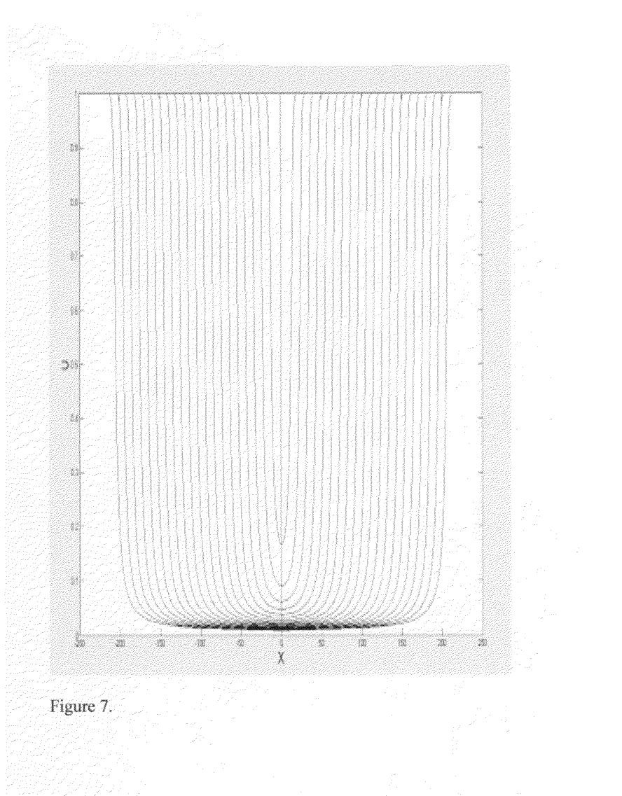

The structure of the solution depends on the parameter m. FIG. 6 shows the solution (4.1) at m=0.001 and t=100n, n=0, . . . ,200. FIG. 7 shows the solution (3.1) at m=1 and t=10n, n=0, . . . ,20.

The solution (4.1) describes the formation and growth of a dry zone in a uniform film of the thickness 1. The size of this dry zone grows linearly with time which can be seen in FIG. 7.

The solution (4.1) is developed at R=−1. At R=1 it reads [39]:

$$X = \pm \frac{2}{\sqrt{m}} {cos}^{- 1} ( \sqrt{\frac{tmU}{2 ( 1 - U )}} ) \pm t \sqrt{m} \cdot tan ( {cos}^{- 1} ( \sqrt{\frac{tmU}{2 ( 1 - U )}} ) ) \qquad ( 4.2 )$$

In Eqs. (4.1) and (4.2) the “±” sign implies that these solutions should be symmetric with respect to X=0.

The solution (4.2) describes the spreading of a wetting film starting from a finite region of the size D of the uniform thickness 1. It follows from Eq. (4.2) that the initial distribution of U has the form:

t=0: U=1, |X|<D; U=0, |X|>D (4.3)

where

D=π/\sqrt{m} (4.4)

5. The Early Stage of Dewetting in the Model (3.1)

At small times the implicit form of the solution (4.1) can be simplified, as the second term on the r. h. s. of this equation is negligible. As a result, at small times Eq. (4.1) can be inverted which yields:

$$U = \frac{2 cosh ( X \frac{\sqrt{m}}{2} )}{2 cosh ( X \frac{\sqrt{m}}{2} ) + mt} \qquad ( 5.1 )$$

It follows from Eq. (5.1) that at R<0 the parameter m characterizes the kinetics of the dewetting process; namely, it is related to the spatial scale of the forming dry zone X** that can be determined at U=½ and at the unit time t=1 as follows:

$${X}^{**} = \frac{{cosh}^{- 1} ( m / 4 )}{m / 4} \qquad ( 5.2 )$$

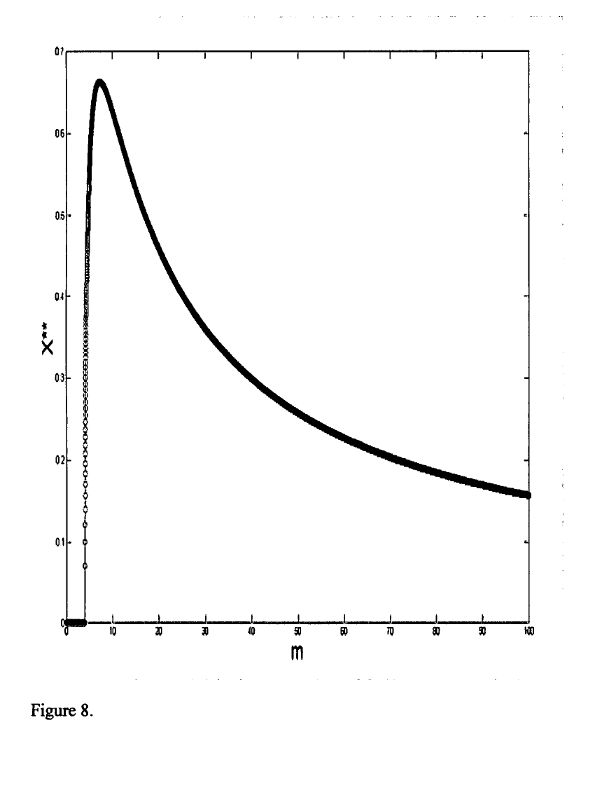

FIG. 8 presents the dependence (5.2). At m below a certain value there are no physically meaningful X**; and there is a certain m value at which X** reaches its maximum. In reality, the parameter m is statistically distributed in space varying between adjacent macroscopic areas; then there is a kinetically most favorable value of m corresponding to the maximum in Eq. (5.2). In other words, we have qualitatively the same description that in the standard model of spinodal decomposition.

Contrary to the case R>0, at R<0 the parameter m in Eq. (4.1) does not have an obvious association to any spatial scale of the initial distribution of U. We are getting close to the central point of this invention which will be addressed in the next section.

6. Dewetting in an Inhomogeneous External Field

The solutions (4.1) and (4.2) match perfectly at X=0 (Mitlin, 2006). This means that the solution:

$$\begin{matrix}X = \frac{2}{\sqrt{m}} {cosh}^{- 1} ( \sqrt{\frac{RtmU}{2 ( 1 - U )}} ) + Rt \sqrt{m} \cdot tanh ( {cosh}^{- 1} ( \sqrt{\frac{RtmU}{2 ( 1 - U )}} ) ) \\ at X > 0 and & ( 6.1 ) \\ X = - \frac{2}{\sqrt{m}} {cos}^{- 1} ( \sqrt{\frac{RtmU}{2 ( 1 - U )}} ) - Rt \sqrt{m} \cdot tan ( {cos}^{- 1} ( \sqrt{\frac{RtmU}{2 ( 1 - U )}} ) ) & ( 6.2 )\end{matrix}$$

at X<0 describes the dewetting process in which the right half-space is maintained at external conditions corresponding to an unstable film state characterized by a parameter, −R, while the left half-space is maintained at external conditions corresponding to a stable film state with a parameter, R (the latter can be interpreted as the Hamaker constant A).

Generally, the external field can be of any kind (e.g. thermal, electrical, magnetic etc.) that can alter the sign of the criticality parameter R. Also, it is assumed that U is the slow and R is the fast mode of the process, so the dynamics of R is not considered here.

Eqs. (6.1) and (6.2) present a solution of the following problem:

$$\begin{matrix}\frac{\partial U}{\partial t} = \frac{\partial }{\partial X} ( {U}^{3} \frac{\partial }{\partial X} ( r ( X ) \frac{\partial G ( U )}{\partial U} ) ) \\ where & ( 6.3 ) \\ r = R ( 1 - 2 H ( X ) ) & ( 6.4 )\end{matrix}$$

and H(X) is the unit step function. Eqs. (6.3) and (6.4) are solved with the following initial and boundary conditions:

$$\begin{matrix}X < - \frac{π}{\sqrt{m}} \text{:} U ( X , 0 ) = 0 & ( 6.5 ) \\ X > - \frac{π}{\sqrt{m}} \text{:} U ( X , 0 ) = 1 & ( 6.6 ) \\ X \to ∞ \text{:} U ( X , t ) = 1 & ( 6.7 ) \\ X \to - ∞ \text{:} U ( X , t ) = 0 & ( 6.8 )\end{matrix}$$

In other words, there is the left half-space with the criticality parameter R and an initial thickness 0; the right half-space with the criticality parameter −R and an initial thickness 1; and a finite region of the size D between these two half-spaces with the criticality parameter R and an initial thickness 1.

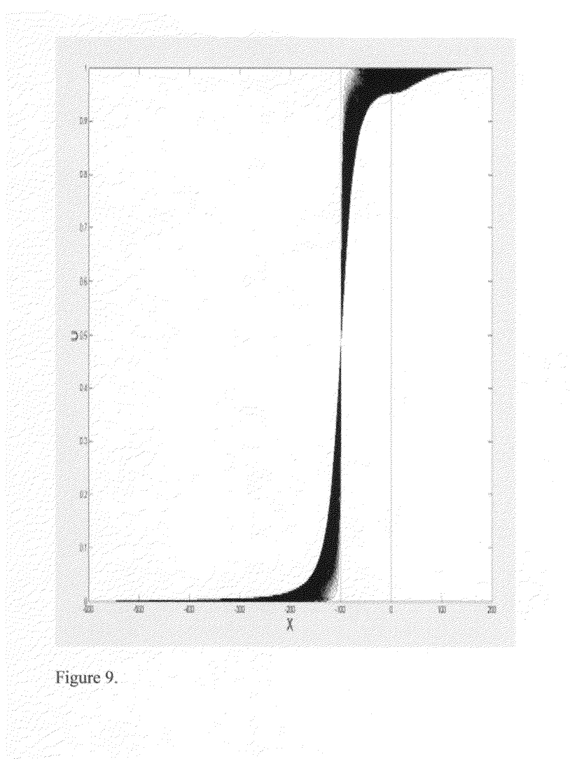

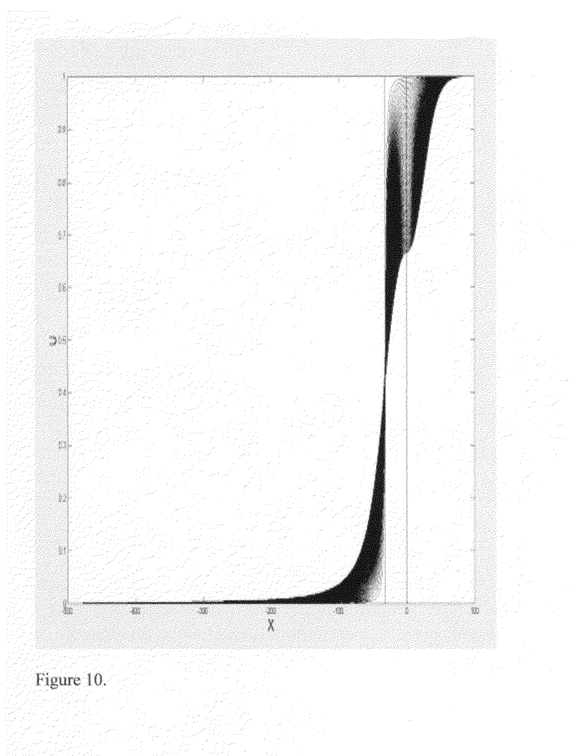

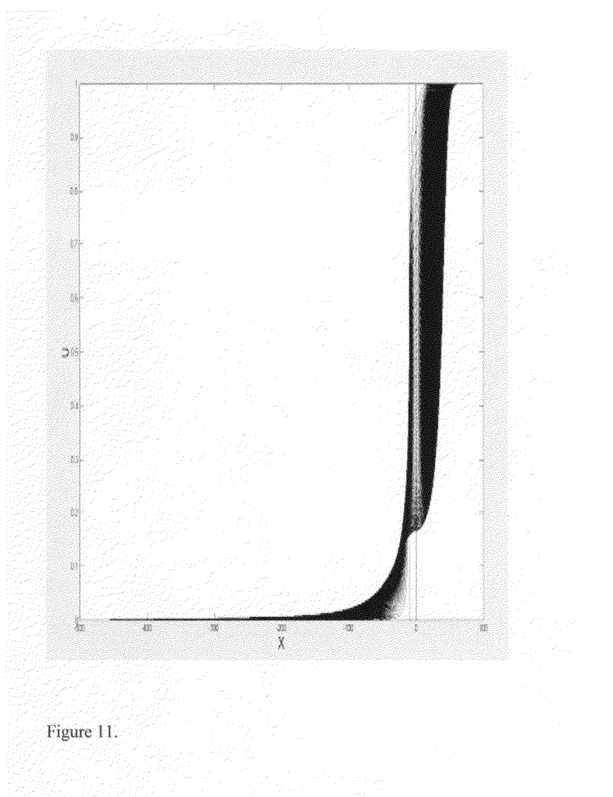

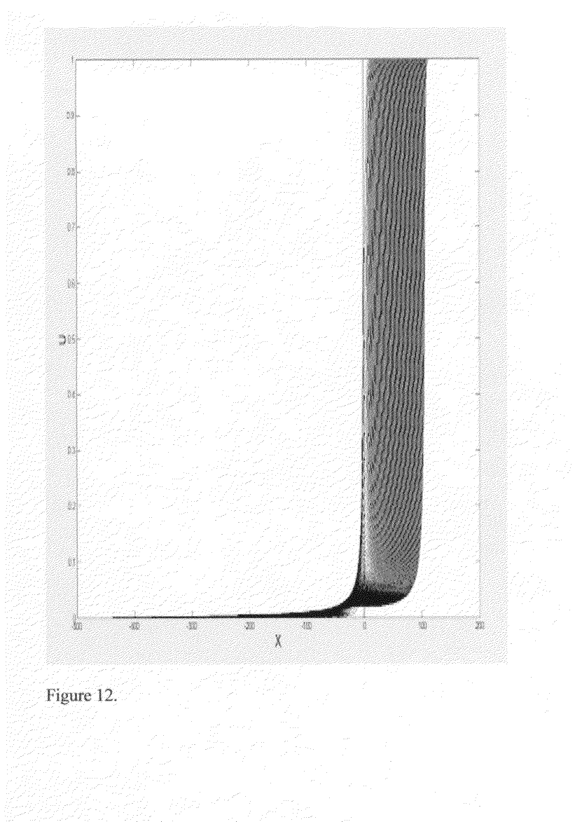

FIGS. 9 to 12 present some examples of this solution. These figures correspond to the value of the parameter m of 0.001, 0.01, 0.1, and 1, respectively. Notice that U profiles are strikingly different at positive and negative r. The difference in the results shown in these figures is due to the difference in the initial distribution of the thickness U and the external parameter R.

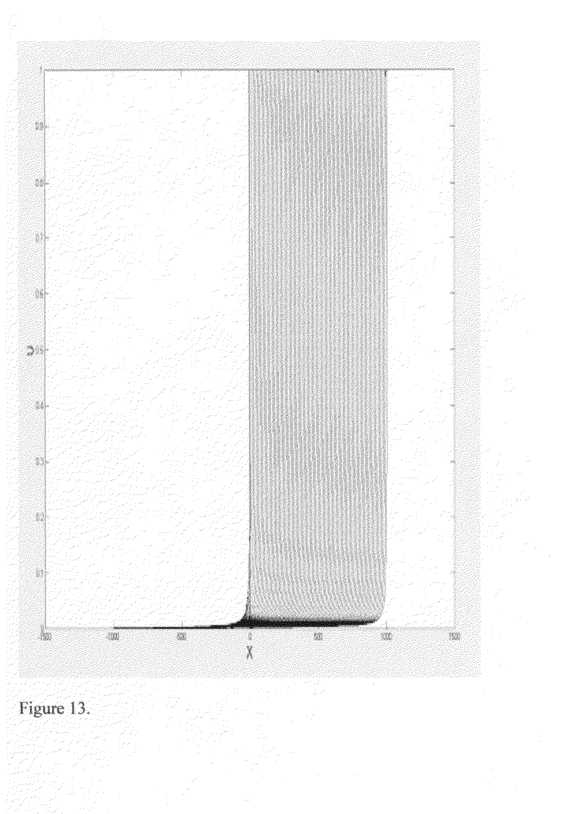

FIGS. 9 to 12 are developed at R=1. FIG. 13 shows how a change in the magnitude of R affects the dynamics of the process.

Introducing Eq. (4.4) into Eq. (6.1) yields the solution in terms of D:

$$X = \frac{2 D}{π} {cosh}^{- 1} ( \sqrt{\frac{{π}^{2} RtU}{2 {D}^{2} ( 1 - U )}} ) + \frac{Rt π}{D} \cdot tanh ( {cosh}^{- 1} ( \sqrt{\frac{{π}^{2} RtU}{2 {D}^{2} ( 1 - U )}} ) ) \qquad ( 6.9 )$$

The dynamics of the dewetting front can be characterized by the value X* at U=½:

$${X}^{*} = \frac{2 D}{π} {cosh}^{- 1} ( \sqrt{\frac{{π}^{2} Rt}{2 {D}^{2}}} ) + \frac{Rt π}{D} \cdot tanh ( {cosh}^{- 1} ( \sqrt{\frac{{π}^{2} Rt}{2 {D}^{2}}} ) ) \qquad ( 6.10 )$$

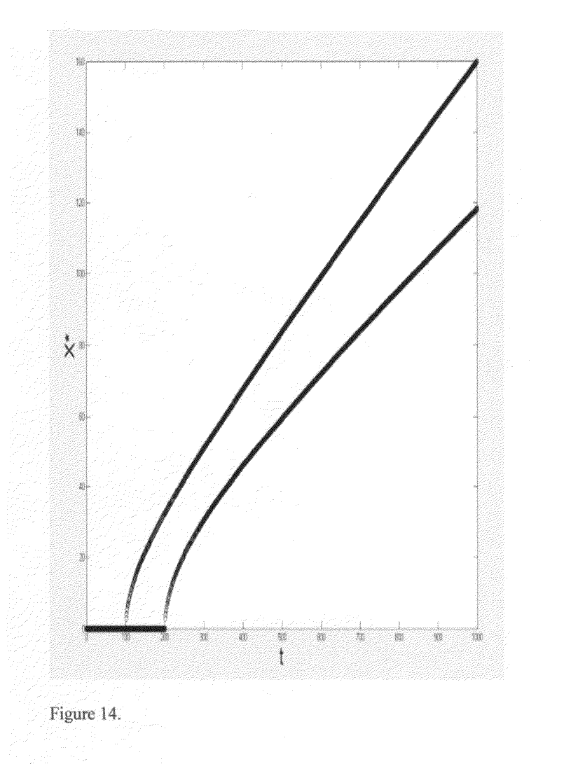

FIG. 14 shows a typical dependence X*(t). At t<200 the whole U profile at X>0 is above the value of ½. At t>200 the front starts advancing, and its advancement soon becomes linear of time:

$${X}^{*} = \frac{Rt π}{D} , t \to ∞ \qquad ( 6.11 )$$

What is surprising is that an increase in D yields a proportionate slowdown of the dewetting process, as the dewetting front advances with the rate ˜R/D; and one can decelerate this advancement as much as one desires by making the size D large enough!

Combining Eqs. (3.8) with Eq. (6.11) yields the following equation for the rate of advancement of the dewetting front:

$$V = \frac{π \vert A \vert}{3 η {d}^{*} {h}^{*}} \approx \frac{\vert A \vert}{η {d}^{*} {h}^{*}} \qquad ( 6.12 )$$

In Eq. (6.12) d* is a dimensional value for the size of the buffer zone, D.

7. Discussion. A Method of a Kinetic Stabilization of a Non-Wetting Film

In the above description we considered two problems. The first problem was the development and growth of a dry zone in an initially uniform liquid film. We observe that the size of a dry zone increases linearly with time. The second problem was an advancement of the dewetting front of a non-wetting film in contact with a dry semi-space through a “buffer” of a wetting film (a finite size zone between two vertical lines in FIGS. 9 to 13). Our results show that such geometry allows the coexistence of a film-covered half-space and a dry half-space. The liquid from the buffer zone redistributes and advances in an initially dry half-space in the form of a thin film precursor. Our results show that the frontal advancement type of dewetting kinetics does require an existence of a finite buffer zone with a different wettability controlled externally. Remarkably, an increase in the buffer size kinetically stabilizes the non-wetting film slowing down the advancement of the dewetting front (Eq. (6.12); also compare FIGS. 9 to 13). The fact that the rate of the advancement of the dewetting front is inversely proportional to the size of the buffer zone suggests that a non-wetting film may be kinetically stabilized on a “hostile” substrate if it contacts a finite buffer zone where, by applying an external action (for instance, by maintaining it at different temperature or externally controlling other relevant properties) the film exists in a wetting state. By controlling the size of the buffer zone and the magnitude of the parameter R a macroscopic kinetic stabilization of the non-wetting film may be possible.

8. Experimental Corroborations of the Theory

We performed a series of experiments to corroborate the theory presented above. In these experiments we applied acrylic craft paint to sticker backing paper. This paper is not wettable with this paint, and the dewetting process is almost instantaneous.

The coating area was rectangular with the sides 6 cm by 3.2 cm demarcated with a fine tip permanent marker. Prior to performing tests, each coating area was cleaned with isopropyl alcohol.

Two groups of tests were conducted in parallel. In the first group a buffer zone was created at the boundary inside and touching the demarcation line of the coating area. The buffer zone was lubricated with Pantene Pro V hair conditioner, applied thinly with a brush. The width of the buffer zone was 0.5 cm. In the second group of tests, there was no buffer application. 1.25 cm³ of paint was placed with a pipette on the coating area and pushed with a small brush to the demarcation lines. It was found that the sticker paper treated with the conditioner became wettable to the acrylic paint.

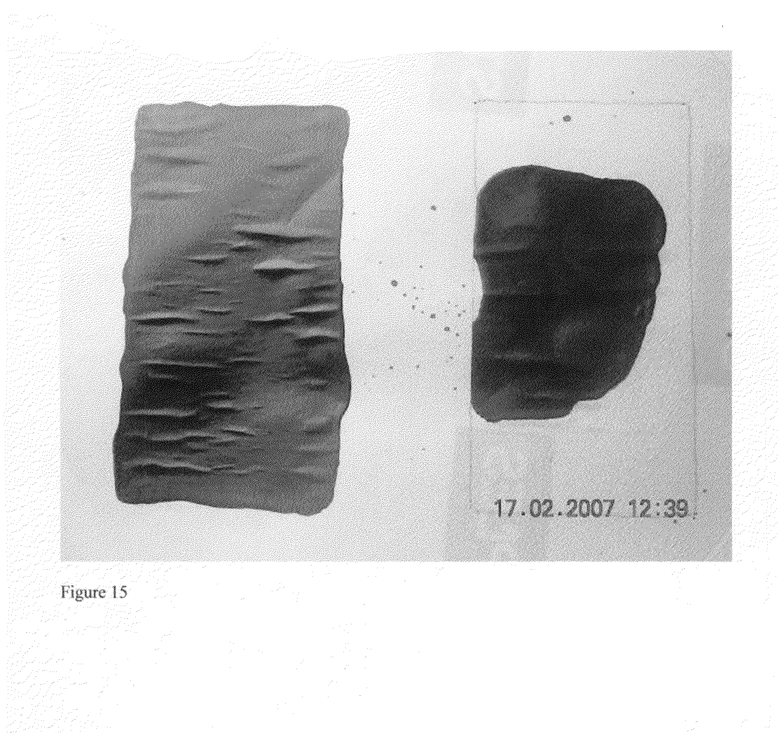

FIG. 15 shows the coating areas in an experiment with a buffer zone (the left rectangle) and with no buffer zone (the right rectangle). In the absence of a buffer zone, the fluid quickly assembles in a smaller area, pooled at the center of the rectangle. The presence of a buffer zone enables one to “stretch” the fluid across the entire coating area. The sticker paper is warped due to the water content of the craft paint.

Thus, the presence of wettable buffer zone does stabilize a nonwetting film on a substrate. For a given amount of fluid in the coating, there exists a characteristic size of the coating area where the coating can be stabilized by means of introducing a buffer zone. In the experiments shown in FIG. 15 the characteristic size is about equal to the area of the rectangle.

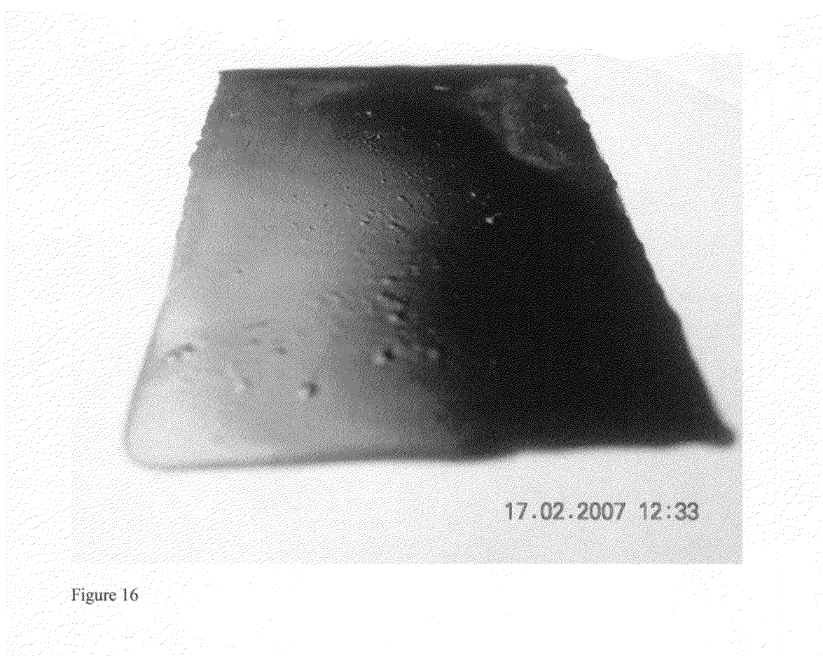

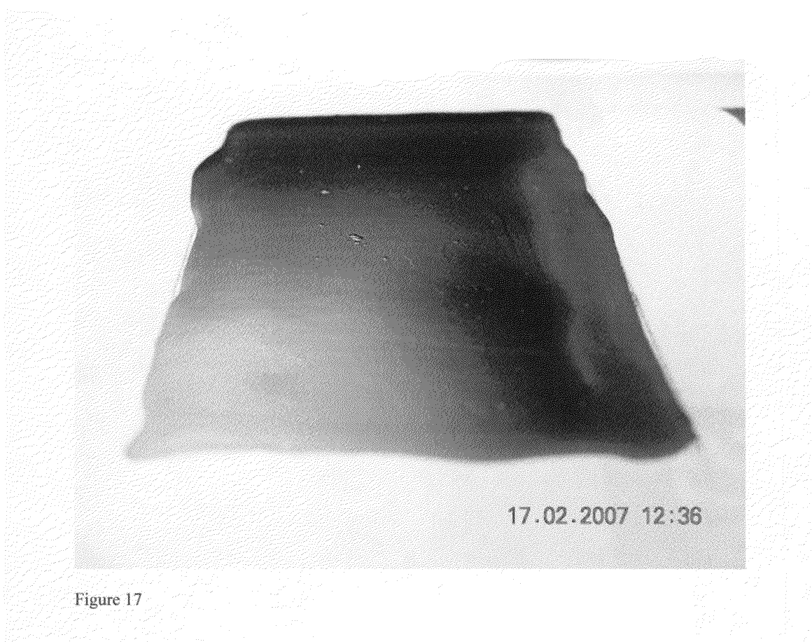

Introducing the buffer zone at the boundary of the coating area is found to have a favorable effect on the coating morphology even when dewetting is not an issue. FIGS. 16 and 17 present results of tests using enamel hobby paint, again on sticker backing paper. With no water content, the enamel did not warp the paper, and the sticker paper is apparently wettable by this type of paint. FIG. 16 shows the coating area in the test without a buffer zone. FIG. 17 shows the coating area with a buffer zone of the width 0.5 cm created along the perimeter of the coating area by lubrication with Pantene Pro V hair conditioner. This treatment improves the wettability of the buffer zone with respect to enamel paint compared to the wettability of the coating area. One can see a dramatic difference between the two surfaces. Without a buffer zone, the coating has many micro-defects. In the presence of a buffer zone, the surface is much smoother.

Experiments were also conducted on wax surfaces (to negate any warping effects of water). These experiments confirmed the favorable effect of a presence of a wettable buffer zone on the coating process.

9. Method of Prevention of Defects in Uniform Coatings

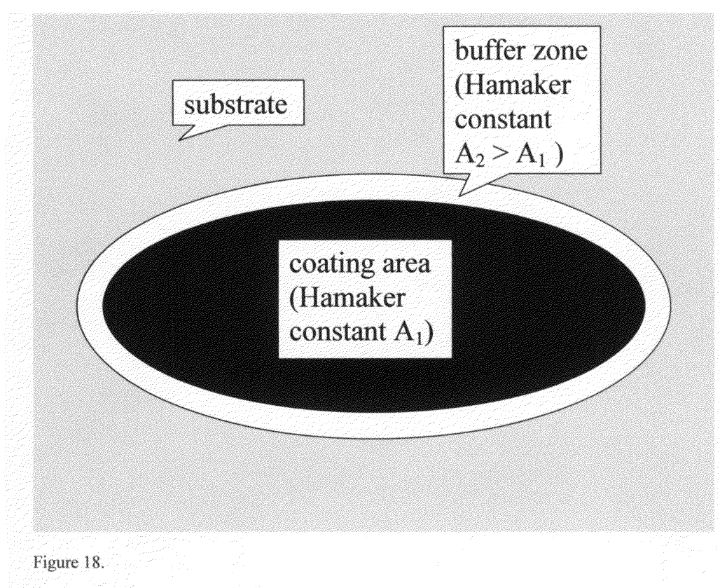

Based on the above, the following method of prevention of defects in a fluid coating of a solid substrate can be proposed. One has to place the coating in an area of the substrate and in a finite buffer zone surrounding that area. The surface of the buffer zone is rendered “more friendly” to the fluid than a surface outside the buffer zone (FIG. 18), where a “more friendly” surface has better wettability with respect to the fluid of the coating. An increase in the width of the buffer zone reduces the number of defects in the coating, as shown in the above description.

The quantitative measure of the wettability of a surface with respect to a fluid is the Hamaker constant whose value, for the surface of the buffer zone, should be larger than the one of the surface in the coating area. Making the surface in the buffer zone friendly to a particular fluid can be accomplished by applying a layer of fluid-“friendly” material to the buffer zone prior to placing the fluid coating. This “friendly” material could simply be a special tape whose adhesion properties are determined by the specific properties of the substrate and the fluid in the coating. This tape would be applied to the border of the coating area prior to applying the coating itself. After the coating is applied and solidified, the tape can be removed.

Another possible way to alter the wettablility of a buffer zone is by applying an external field of a predefined strength for a predefined period of time to the buffer zone. The external field can be of any kind that improves the wettability of the surface in the buffer zone with respect to the fluid in the coating compared to the wettability of the surface in the coating area.

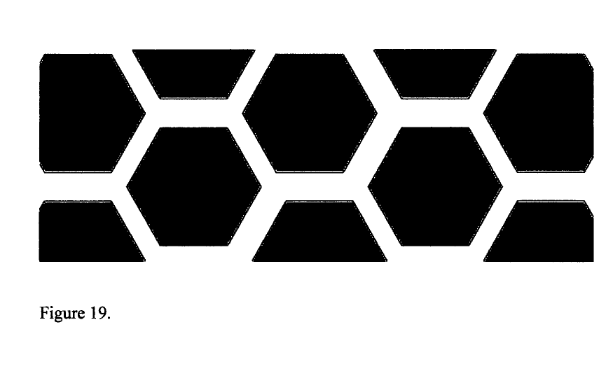

One can also envision a method of creating wettability-reinforced coatings for the coatings industry, as follows. For given fluid and substrate, choose a buffer material with a better wettability with respect to the fluid than the wettability of the substrate; and place a mesh of the buffer material on the substrate. The mesh should have an approximately periodical structure with a period rendering the stability of a coating of the fluid on the substrate (FIG. 19).

Our results show that placing fluid on such a surface yields, for a given amount of fluid, a coating with fewer defects than in a similar coating on a similar surface but without the mesh. Alternatively, for a given quality of coating (e.g. the number of defects per unit area), the amount of fluid required for coating such a surface is smaller than the one required for coating a similar surface but without the mesh. Because of the presence of a mesh of a buffer material one should expect such wettability-reinforced coatings to have some special properties (for example, they may be more stress-resistant than similar coatings without the mesh).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of kinetic stabilization of a fluid film in an area of a “hostile” substrate comprising:
rendering the surface in a finite buffer zone adjacent to said area “friendly” to the fluid of said film; and
placing said film in said area and said buffer zone;
wherein said “friendly” buffer zone has better wettability with respect to the fluid of said film than said “hostile” area;
the wider the buffer zone the slower the film recedence from said area of the substrate.

2. The method of claim 1 wherein the wettability of said area or said buffer zone with respect to said fluid is determined by the Hamaker constant;
wherein the Hamaker constant of said area with respect to said fluid is smaller than the Hamaker constant of said buffer zone.

3. The method of claim 1 wherein said rendering comprises applying a layer of fluid-“friendly” material to said buffer zone prior to placing said film.

4. The method of claim 1 wherein said rendering comprises applying an external field of a predefined strength for a predefined period of time to said buffer zone;
wherein said external field can be of any kind that improves the wettability of said buffer zone with respect to the fluid of said film compared to the wettability of said area.

5. A method of prevention of defects in a fluid coating of a substrate for the coatings industry comprising:
placing said fluid coating in an area of a substrate and in a finite buffer zone surrounding the area wherein the surface in the buffer zone has better wettability with respect to the fluid coating than the area;
the wider the buffer zone the less likely the formation of defects in said fluid coating in said area.

6. The method of claim 5 wherein the wettability of said area or said buffer zone with respect to said fluid coating is determined by the Hamaker constant;
wherein the Hamaker constant of said area with respect to said fluid coating is smaller than the Hamaker constant of said buffer zone.

7. The method of claim 5 wherein said rendering comprises applying a layer of a material to said buffer zone prior to placing said fluid coating;
wherein the wettability of said material with respect to said fluid coating is better than the wettability of said area.

8. The method of claim 5 wherein said rendering comprises applying an external field of a predefined strength for a predefined period of time to said buffer zone;
wherein said external field can be of any kind that improves the wettability of said buffer zone with respect to said fluid coating compared to the wettability of said area.

9. A wettability-reinforced coating comprising:
for given fluid and substrate, choosing a buffer material with a better wettability with respect to said fluid than the wettability of said substrate; and placing a mesh of said buffer material on said substrate;
wherein said mesh has an approximately periodical structure with a period rendering the stability of a coating of said fluid on said substrate.

10. The method of claim 9 further comprising placing said fluid on said substrate;
for a given amount of fluid, said wettability-reinforced coating has fewer defects than a similar coating on a similar substrate without said mesh.

11. The method of claim 9 further comprising placing said fluid on said substrate;
for a given number of defects per unit surface, said wettability-reinforced coating requires less fluid than a similar coating on a similar substrate without said mesh.
